(19) United States
(12) Patent Application Publication
(10) Pub. No.: US 2008/0123552 A1
(43) Pub. Date: May 29, 2008

(54) METHOD AND SYSTEM FOR SWITCHLESS BACKPLANE CONTROLLER USING EXISTING STANDARDS-BASED BACKPLANES

(75) Inventor: David Shannon Slaton, Huntsville, AL (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 11/564,501

(22) Filed: Nov. 29, 2006

(51) Int. Cl. H04L 12/28

(52) U.S. Cl. 370/254

(57) ABSTRACT

Disclosed herein is an electronic system and method including a backplane including a circuit board and a plurality of slots, a plurality of nodes operably connected to a corresponding slot of the plurality of slots, and a central control system operably connected to a hub slot of the plurality of slots. Each node slot is required to be routed only to the hub slot providing point-to-point interconnect to each node and the central control system has a point-to-point interconnect or direct link without a switch to each node.

### BACKGROUND OF THE INVENTION

The disclosed invention relates to a method and apparatus for a switchless backplane controller using existing or common standards-based backplanes. More particularly, it relates to a method and apparatus for a switchless backplane controller, which uniquely applies existing or common standard fabric backplanes to allow communication from a central control central processing unit (“CPU”) to slave CPUs alleviating the need for an intervening fabric switch and the signaling latencies associated with the fabric switch.

Typical systems using high-speed serial input/output (“I/O”) like Gigabit Ethernet and PCI-express make use of a central switch to allow boards in any slot to communicate with boards in any other slot. This approach is typical in standards like AdvancedTCA™ or PICMG 2.16.

AdvancedTCA™ is the name that the PCI Industrial Computer Manufacturers Group (“PICMG”) has chosen to describe the new architecture. It stands for Advanced Telecom Computing Architecture, and it is pronounced “Advanced Tee-See-Aye.” This is analogous to the term “CompactPCI” being used to describe the PICMG 2.x family of specifications.

The AdvancedTCA™ is the latest open industry specification for building high-performance telecommunications and data communications systems. Developed by the PICMG consortium, it is poised to answer the requirements of standardized building blocks for the next generation of carrier grade communications equipment. This series of specifications incorporates the latest trends in high speed interconnect technologies, next generation processors and improved reliability, manageability and serviceability to help decrease cost and offer time-to-market networking solutions.

The standard PICMG 3 backplane is a “full mesh”, wherein every slot has a dedicated link to every other slot. This provides the potential, in aggregate, for terabit/second data transfers within a single shelf, or chassis. Very high performance systems will use the full mesh for maximum throughput. The popular “dual star” and “single star” topologies are also supported in PICMG 3 on the same backplane, as a single or dual star is just a subset of a full mesh, with only a portion of the links used. Star topologies have a lower total bandwidth than a full mesh, but are less costly to implement.

Backplanes exist that conform to these standards and route the high-speed serial I/O signals from the central switch (known as the “Hub”) in slot X+1 to multiple other slots (known as “Nodes”) in slots 1 through X. FIG. 1 illustrates this system configuration as a traditional PICMG 2.16 approach. In this approach, all of the node devices communicate with one-another via a switch in the hub slot of a backplane 12. In this way, latencies, that for some applications are unnecessary, between the switch and any of the I/O devices, are realized because of the communication path through the switch.

In some cases there is only a need to have a master controller single board computer (“SBC”) in the system, which must communicate with a multitude of input/output (“I/O”) or other computer boards, but it is not necessary that the I/O or other computer boards talk to each other. It is also necessary that the communication path from the SBC to the I/O board have as low a latency as possible. In such cases, the extra latency introduced by a fabric switch is undesirable.

For example, U.S. Pat. No. 5,983,260 describes an interconnect system utilizing serial fabrics and a fabric switch to connect all modules in the system together. As a result, this system incurs the latencies of the switch hardware, which for some applications might be undesirable or unnecessary. U.S. Pat. No. 6,728,807 and U.S. Patent Application No. 2002/0163910A1 describe similar interconnect systems as that in U.S. Pat. No. 5,983,260. The interconnection system in U.S. Pat. No. 5,983,260 is very common and typical of fabric backplane designs.

Accordingly there is a need in the art for a method and apparatus which applies existing standard fabric backplanes to allow communication from a central control CPU or SBC to slave CPUs or I/O boards in which a need for an intervening fabric switch and the signaling latencies associated therewith are alleviated.

### BRIEF DESCRIPTION OF THE INVENTION

Disclosed herein is an electronic system including a backplane having a circuit board and a plurality of slots, a plurality of nodes operably connected to a corresponding slot of the plurality of slots, and a central control system operably connected to a hub slot of the plurality of slots. Each node slot is required to be routed only to the hub slot providing point-to-point interconnect to each node and the central control system has a direct link without a switch to each node.

Further disclosed herein is an electronic system including: a backplane including a circuit board and a plurality of slots; a plurality of nodes operably connected to a corresponding slot of the plurality of slots; and a central control system operably connected to a hub slot of the plurality of slots, the central control system having separate dedicated controllers for each communication channel to communicate with a respective node. Each node slot is required to be routed only to the hub slot providing point-to-point interconnect to each node and the central control system has a direct link without a switch to each node.

Further disclosed herein is a method for a switchless backplane. The method includes: providing a backplane including a circuit board and a plurality of slots; operably connecting a plurality of nodes to a corresponding slot of the plurality of slots; and operably connecting a switchless central control system to a hub slot of the plurality of slots, wherein each node slot is required to be routed only to the hub slot providing point-to-point interconnect to each node and the central control system has a direct link without a switch to each node.

### BRIEF DESCRIPTION OF THE DRAWINGS

The following descriptions should not be considered limiting in any way. With reference to the accompanying drawings, like elements are numbered alike:

FIG. 1 depicts a block diagram of a conventional approach using a PICMG 2.16 or AdvancedTCA™ standard approach fabric backplane illustrating all node devices communicating with one another via a switch in a hub slot of the plurality of card slots;

FIG. 2 depicts a block diagram of the backplane of FIG. 1 with an SBC hub device in the hub slot instead of the switch in communication with each of the plurality of card slots in accordance with an exemplary embodiment of the present invention;

FIG. 3 depicts a block diagram of the backplane of FIG. 1 in which the switch of FIG. 1 is replaced with a central processor (hub board) in communication via a point-to-point interconnection with a variety of input/output devices (nodes) making use of the well-established mechanical/signal standard of PICMG 2.16 or AdvancedTCA™ as the backplane in accordance with exemplary embodiments of the present invention;

FIG. 4 depicts a block diagram of an AdvancedTCA™ backplane standard illustrating two channels connecting the hub board (central processor) to the node boards in accordance with another exemplary embodiment of the present invention.

FIG. 5 depicts a block diagram of a full mesh backplane having a plurality of independent central control systems in a same chassis, each in direct communication with a respective set of node boards in accordance with an alternative exemplary embodiment of the present invention.

### DETAILED DESCRIPTION OF THE INVENTION

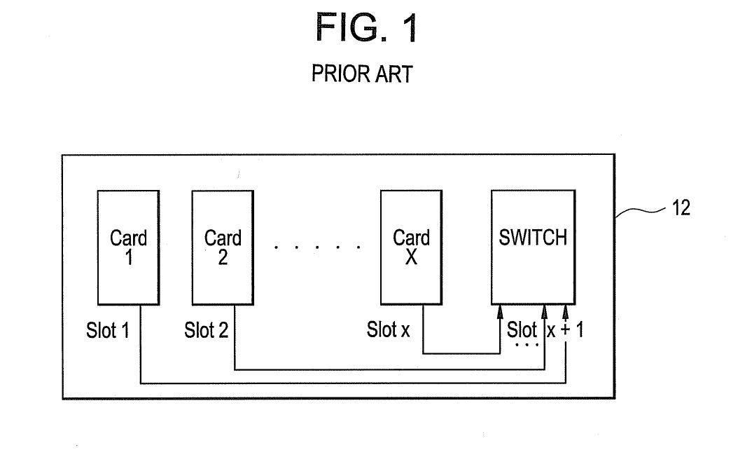

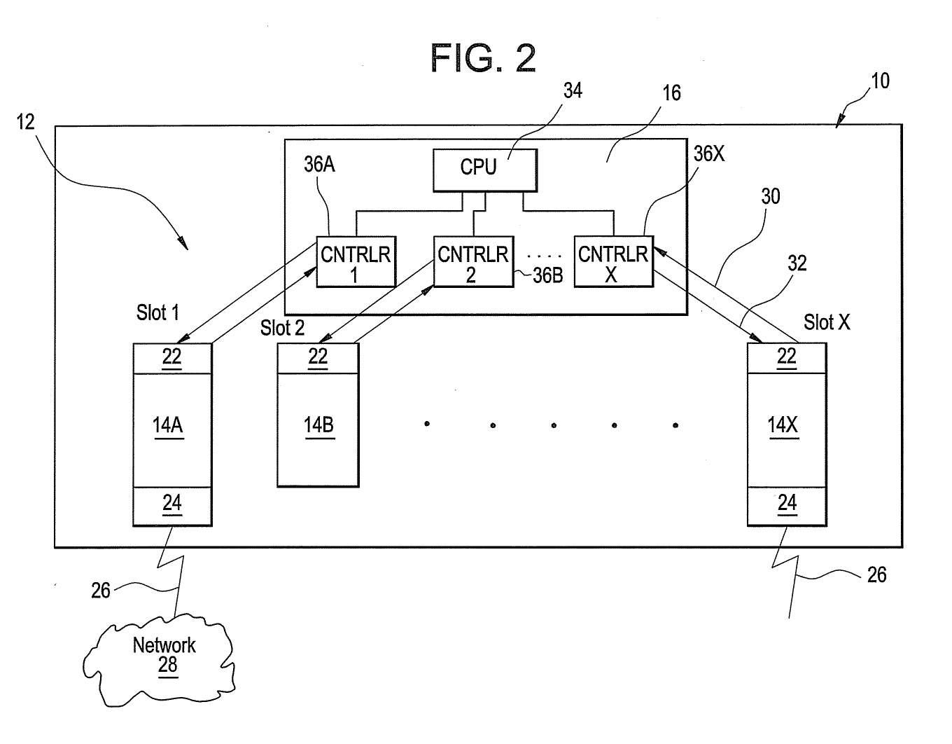

FIG. 2 shows an exemplary system and method of replacing the switch hub with a compute node, which, utilizing the existing standard PICMG 2.16 backplane, now has a direct communication path to any of the I/O devices of the backplane, and avoids the switch latencies of the prior art illustrated in FIG. 1. FIG. 2 is a block diagram illustrating a network switch 10 in which a backplane 12 provides a point-to-point connection between each port blade 14A through 14X and a single board computer (“SBC”) 16. Backplane 12 is a printed circuit board which includes a number of expansion slots 22, such as four or sixteen, for example, for receiving and coupling a port blade 14 or the SBC 16 to the backplane 12.

Several port blades 14 includes one or more media ports 24 for bi-directionally communicating via a corresponding external telecommunication link 26 to a network 28, which may be a wide area network (“WAN”), a local area network (“LAN”) or other digital network. Port blade 14B, also referred to as a processor blade or node, does not include a media port in this embodiment.

Each port blade 14 also includes an output connection 30 and an input connection 32 for communicating data with the SBC 16. In an exemplary embodiment, the SBC 16 includes a central processor unit (CPU) 34, which is operably connected to a respective controller 36 of a plurality of controllers 36A to 36X. Each controller 36 is operably connected to a respective port blade 14. (e.g., “controller 1” is connected to “slot 1” . . . and “controller X” is connected to “slot X”).

Accordingly, the above exemplary system and method exemplified in FIG. 2 uniquely applies existing standard fabric backplanes to allow communication from-a central control CPU 34 to slave CPUs 14A-14X (and/or I/O devices) in a novel way that removes a need for an intervening fabric switch (FIG. 1) and the signaling latencies associated with a fabric switch. In special cases where nodes do not need to communicate directly with other nodes, and that the latency introduced by a hub switch would be unacceptable, the hub switch can be replaced with the hub SBC 16 which dedicates separate serial I/O controllers 36 for each communication channel to communicate with the port blades or node boards 14.

Using this exemplary system and method, the switch hub device is replaced with an SBC hub device with a CPU 34 which has a direct link (e.g., without a switch as in FIG. 1) to each I/O or compute device 14 in the system, avoiding unnecessary switching latencies. Additionally, the SBC 16 can take advantage of the existing bus structure, mechanical structures, and routing of the existing standard chassis or backplane 10.

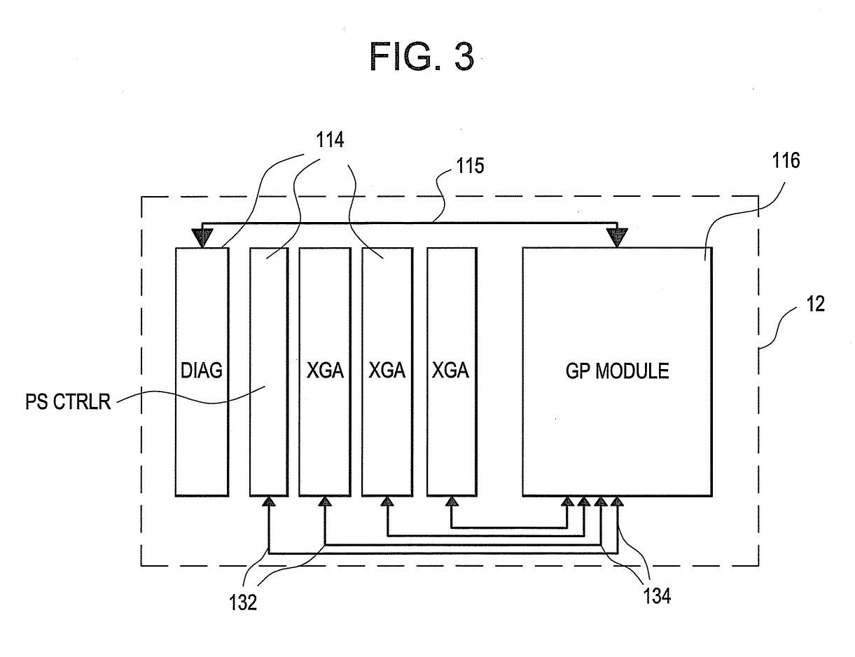

Referring to FIG. 3, the above described exemplary system and method of applying a switched-fabric chassis to applications, which require lower latencies may be implemented in a magnetic resonance imaging (“MRI”) control system, for example, but is not limited thereto, in which a central processor 116 (depicted as the “GP Module”) must communicate with a variety of input/output (“I/O”) devices 114 (depicted as “XGA” and a “PS Controller”) through high-speed, low latency links. FIG. 3 depicts a block diagram of the backplane 12 of FIG. 1 in which the switch of FIG. 1 is replaced with a central processor (hub board) 116 (e.g., a GP Module as illustrated in FIG. 3) in communication via a point-to-point interconnection illustrated with lines 132 and 134 with a variety of input/output devices (nodes) 114 (e.g., a plurality of XGAs and a PS CTRLR, as illustrated in FIG. 3) making use of the well-established mechanical/signal standard of PICMG 2.16 as the backplane in accordance with an exemplary embodiment of the present invention.

By replacing the switch illustrated in FIG. 1 with the GP Module 116, dedicated (e.g., non-switched) point-to-point interconnection is created between the GP Module 116 and the XGAs/PS CTRLR 114. In addition a PCI bus 115 may be available for less critical data flow as illustrated between PS CTRLR 114 and the GP Module 116. It will be recognized by those skilled in the art that the switch of FIG. 1 may be replaced with the central processor (hub board) 116 in communication via a point-to-point interconnection with the variety of input/output devices (nodes) 114 making use of the well-established mechanical/signal standard of the AdvancedTCA™ as the backplane in accordance with an alternative exemplary embodiment of the present invention.

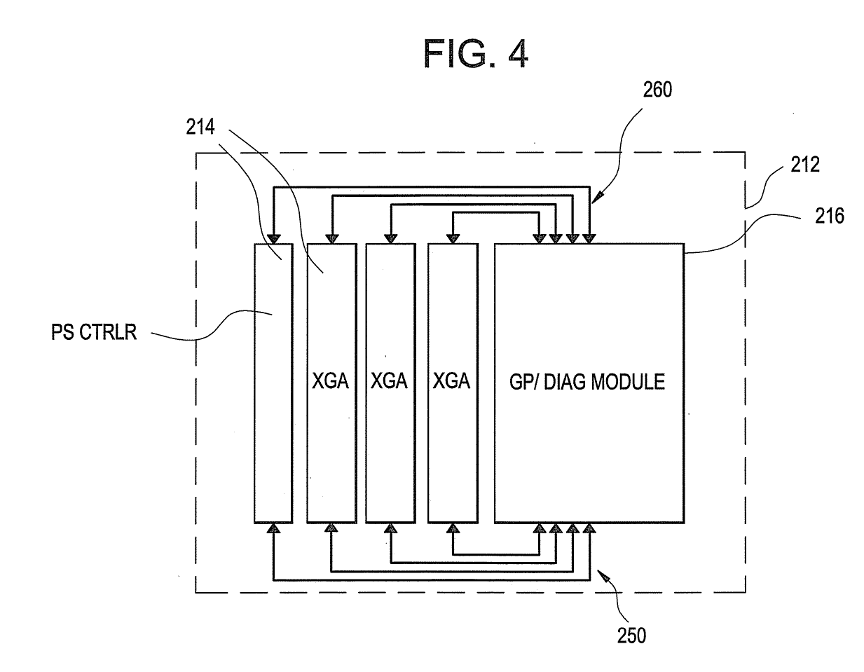

FIG. 4 illustrates a block diagram of an AdvancedTCA™ backplane standard illustrating two channels connecting the hub board (central processor) 216 to the node boards 214 in accordance with another exemplary embodiment of the present invention. FIG. 4 illustrates a backplane 212 including two high-performance communication channels in a standard AdvancedTCA™ chassis. The two channels include a base channel generally shown at 250 and a fabric channel generally shown at 260. The AdvancedTCA™ standard allows the “Fabric” channel to be Gigabit Ethernet, InfiniBand, Rapid I/O, PCI-express, or any other serial bus standard defined in the future. The fabric channel 260 can be used to increase data flow. In addition, technologies like InfiniBand and PCI-Express can possibly offer lower latencies than Gigabit Ethernet.

In other words, on some backplane standards (e.g., AdvancedTCA™), there are actually two channels connecting the hub board to the node boards. Therefore, the idea in the present disclosure may be applied to both channels 250 and 260 (or more if the backplane standard provided them) or it may be applied to only one channel, leaving the second channel available for the traditional “switched” method of interconnect as illustrated in FIG. 1. Alternatively, by applying the idea disclosed in this application to both channels 250 and 260, such a backplane 212 would allow for point-to-point switchless communication to the node boards 214 using two different fabric standards (for example, PCI-express and Gigabit Ethernet).

As discussed above, on “full mesh” systems, the backplane routes each slot to every other slot. In such a conventional system, every board must have a switching resource on it. Therefore, in such a full mesh system, any slot can be designated as the “central control system” and be used to communicate to all of the other slots. In exemplary embodiments of this invention as described above and implemented in a full mesh system would allow any slot (designated as the “central control system slot”) to communicate to any other set of slots in a point-to-point manner by removing the switching resources and placing dedicated controllers on the “central control system”.

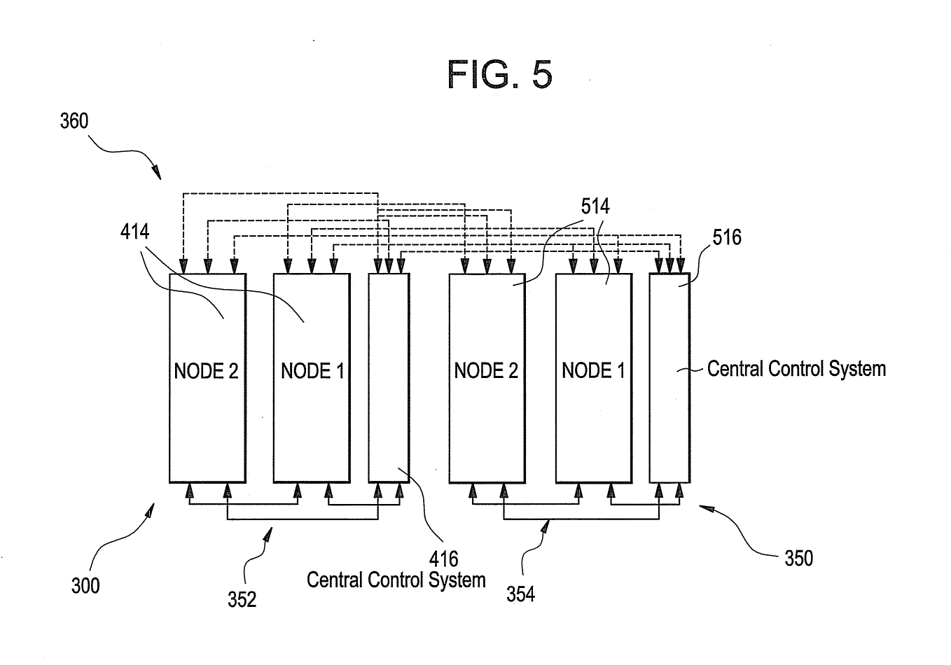

FIG. 5 depicts a block diagram of a full mesh backplane 360 having a plurality of independent central control systems 416 and 516 in a same chassis, each in direct communication with a respective set of node boards 414 and 514 in accordance with an alternative exemplary embodiment of the present invention. FIG. 5 illustrates a full mesh system used to provide for the plurality of independent central control systems 416 and 516 in the same chassis, each with their own set of slots they can directly communicate with. The full mesh backplane 300 illustrates two sets of interconnects 350 and 360. The interconnects 360 are not used in this exemplary embodiment, while the set of interconnects 350 includes interconnects 352 and 354. Interconnects 352 allow the central control system 416 to communicate directly with either of the node boards 414 without using a switch and interconnects 354 allow the central control system 516 to communicate directly with either of the node boards 514 without using a switch. Because a full mesh backplane routes all slots to every other slot, a single chassis can be portioned into separate “central control system”/“node board” groups.

For example, a full mesh chassis can support two central control systems 416 and 516 each with two associated node boards 414 and 514, respectively, in which they can communicate with. Because none of the boards of the backplane 300 have switching resources, the node boards 414 and 514 cannot communicate with each other, nor can the central control system 416 communicate with the node boards 514 directly connected to the central control system 516. However, the central control system 416 can communicate with to its set of node boards 414 without latencies of a switch, and the central control system 516 can communicate with its set of node boards 514 without latencies of a switch, all in the same chassis.

It should be appreciated by one skilled in the art that the potential benefits for parallel computing clusters may provide opportunities to create a product exploiting the present invention. In particular, parallel computing problems categorized in the industry as “Embarrassingly Parallel” are well suited to take advantage of exemplary embodiments of the system and method disclosed herein for problems including non-real-time rendering of computer graphics, brute force searches in cryptography, game tree traversal in artificial intelligence, ray tracing, image processing, and monte carlo calculations, for example, but is not limited thereto.

Advantages of exemplary embodiments of the present invention may include: avoiding unnecessary latencies in a novel way by placing the central control system in the hub slot (which would traditionally be occupied by the fabric switch), allowing for a direct point to point link from the central control system (the hub) to the I/O or compute devices (the nodes) using existing standards based fabric backplanes. The system and method described herein make use of the existing standards-based fabric backplane (like PICMG 2.16 or AdvancedTCA™) in a novel way by replacing the traditional switch in the hub slot with a control system like an SBC, providing direct point-to-point interconnect to the node devices. As discussed above, U.S. Pat. No. 5,983,260 suffers from latencies due to intervening switches, but also suffers from the complexity of placing the switching resources on each and every board in the system, and from the high cost of developing a fabric backplane that wires every slot to every other slot (known as a “full mesh”). The system and method of the present invention do not require any switching resources to be located on either the node boards or the hub board and avoids the higher cost of a full mesh backplane by requiring each slot to be routed only to the hub slot (as is traditionally the case in PICMG 2.16 or AdvancedTCA™ applications).

While the embodiments of the disclosed method and system have been described with reference to exemplary embodiments, it will be understood by those skilled in the art that various changes may be made and equivalents may be substituted for elements thereof without departing from the scope of the embodiments of the disclosed method and system. In addition, many modifications may be made to adapt a particular situation or material to the teachings of the embodiments of the disclosed method and system without departing from the essential scope thereof. Therefore, it is intended that the embodiments of the disclosed method and system not be limited to the particular embodiments disclosed as the best mode contemplated for carrying out the embodiments of the disclosed method and system, but that the embodiments of the disclosed method and system will include all embodiments falling within the scope of the appended claims.

What is claimed is:

1. An electronic system comprising:
a backplane including a circuit board and a plurality of slots;
a plurality of nodes operably connected to a corresponding node slot of the plurality of slots; and
a central control system operably connected to a hub slot of the plurality of slots,
wherein each node slot is required to be routed only to the hub slot providing point-to-point interconnect to each node and the central control system has a direct link without a switch to each node.

2. The system of claim 1, wherein the backplane is a common standards-based fabric backplane.

3. The system of claim 2, wherein the common standards-based fabric backplane includes PICMG 2.16 or Advanced TCA™.

4. The system of claim 1, wherein each node is at least one of a compute device and an input/output device.

5. The system of claim 1, wherein the central control system is a single board computer (SBC).

6. The system of claim 5, wherein the SBC includes a central processing unit (CPU) operably connected to a dedicated controller operably connected to a respective node of the plurality of nodes.

7. The system of claim 5, wherein a hub switch is replaced with the hub SBC which dedicates separate serial I/O controllers for each communication channel to communicate with a respective node of the plurality of nodes.

8. The system of claim 1, wherein the plurality of nodes and central control system are absent any switching resources.

9. The system of claim 1, wherein the central control system provides dedicated non-switched point-to-point interconnection to each of the plurality of nodes.

10. An electronic system comprising:
a backplane including a circuit board and a plurality of slots;
a plurality of nodes operably connected to a corresponding node slot of the plurality of slots; and
a central control system operably connected to a hub slot of the plurality of slots, the central control system having separate dedicated controllers for each communication channel to communicate with a respective node,
wherein each node slot is required to be routed only to the hub slot providing point-to-point interconnect to each node.

11. A method for a switchless backplane, the method comprising:
providing a backplane including a circuit board and a plurality of slots;
operably connecting a plurality of nodes to a corresponding node slot of the plurality of slots; and
operably connecting a switchless central control system to a hub slot of the plurality of slots,
wherein each node slot is required to be routed only to the hub slot providing point-to-point interconnect to each node and the central control system has a direct link without a switch to each node.

12. The method of claim 11, wherein the backplane is a common standards-based fabric backplane.

13. The method of claim 12, wherein the common standards-based fabric backplane includes PICMG 2.16 or Advanced TCA™.

14. The method of claim 11, wherein each node is at least one of a compute device and an input/output device.

15. The method of claim 11, wherein the central control system is a single board computer (SBC).

16. The method of claim 15, wherein the SBC includes a central processing unit (CPU) operably connected to a dedicated controller operably connected to a respective node of the plurality of nodes.

17. The method of claim 15, further comprising replacing a hub switch with the hub SBC which dedicates separate serial I/O controllers for each communication channel to communicate with a respective node of the plurality of nodes respective nodes.

18. The method of claim 11, wherein the plurality of nodes and central control system are absent any switching resources.

19. The method of claim 11, wherein the central control system provides point-to-point interconnection to each of the plurality of nodes.
